(19) United States
(12) Patent Application Publication
(10) Pub. No.: US 2020/0159027 A1
(43) Pub. Date: May 21, 2020

(54) HEAD-MOUNTED DISPLAY WITH UNOBSTRUCTED PERIPHERAL VIEWING

(71) Applicant: Facebook Technologies, LLC, Menlo Park, CA (US)

(72) Inventors: Nirav Rajendra Patel, San Francisco, CA (US); Yi-Chen Kuo, Santa Clara, CA (US)

(21) Appl. No.: 16/393,766

(22) Filed: Apr. 24, 2019

Related U.S. Application Data
(60) Provisional application No. 62/770,140, filed on Nov. 20, 2018.

(51) Int. Cl. G02B 27/01; G02B 1/11

(52) U.S. Cl. CPC G02B 27/0176; G02B 27/0179; G02B 2027/0158; G02B 2027/0169; G02B 2027/0156; G02B 1/11

(57) ABSTRACT

The disclosed head-mounted display may include (1) a display unit configured to display computer-generated imagery to a user and (2) a housing that retains the display unit. When the head-mounted display is mounted on the user's head and the display unit is positioned in a forward field of view of the user, the display unit may obstruct at least a portion of the user's forward field of view, and the housing may be dimensioned to provide the user with a substantially unobstructed peripheral view of a real-world environment of the user. Various other methods, systems, and devices are also disclosed.

### CROSS REFERENCE TO RELATED APPLICATION

This application claims the benefit of U.S. Provisional Application No. 62/770,140, filed 20 Nov. 2018, the disclosure of which is incorporated, in its entirety, by this reference.

### BACKGROUND

Virtual-reality (VR) devices, augmented reality devices, and other artificial reality devices (collectively referred to as artificial-reality devices) can provide a rich, immersive experience that enables users to interact with virtual objects and/or real objects that have been virtually augmented in some fashion. While artificial-reality devices are often utilized for gaming and other entertainment purposes, they are also commonly employed for purposes outside of recreation. For example, governments may use them for military training simulations, doctors may use them to practice surgery, and engineers may use them as visualization aids.

One example of an artificial-reality device is a head-mounted display (HMD) that fully immerses a user in a VR or other alternate reality experience. Conventional HMDs like this typically include a display housing that, when worn, prevents light from the user's external environment from entering the display housing and, thus, the user's field of view. While such a configuration may enhance the user's VR experience, this housing also prevents the user from viewing the real-world environment, which may make it difficult for the user to interact with real-world objects (including objects that are displayed and/or augmented in some fashion in VR). For example, a user sitting at a desk and wearing an HMD may find it difficult to operate a computer keyboard, a mouse, a stylus, or the like since the HMD (and, in particular, the HMD's display housing) blocks the user's view of such objects.

### SUMMARY

As will be described in greater detail below, the present disclosure is generally directed to an HMD device configured to provide a user with a substantially unobstructed peripheral view of the user's real-world environment. In one example, an HMD may include (1) a display unit configured to display computer-generated imagery to a user and (2) a housing that retains the display unit. The HMD may be mounted on the user's head and the display unit may be positioned in a forward field of view of the user. The display unit may be dimensioned to obstruct at least a portion of the user's forward field of view, and the housing may be dimensioned to provide the user with a substantially unobstructed peripheral view of a real-world environment of the user.

In one embodiment, the HMD may further include a positioning mechanism that mechanically couples the display unit to the housing and that adjustably positions the display unit between at least (1) a viewing position in which the display unit is positioned in the user's forward field of view and (2) a non-viewing position in which the display unit is positioned substantially outside of the user's forward field of view.

In another embodiment, the HMD may further include one or more optical elements in optical communication with the display unit. The optical elements may provide a focused view of the computer-generated imagery. In this embodiment, the optical element may include an anti-reflective coating that suppresses stray light from the user's real-world environment.

In another embodiment, the HMD may further include a removable enclosure that removably attaches to the housing to block the user's peripheral view of the real-world environment. In this embodiment, the removable enclosure may include a main body, and an attachment mechanism, coupled to the main body, that is configured to removably attach the removable enclosure to the housing. For example, the attachment mechanism may include a compression fit attachment that snaps to one or more eye cups configured with the housing.

In another embodiment, the housing may include a nose grip module that adjustably secures the housing to the user's face. In this example, the housing may further include a linear actuator configured with the housing to move the nose grip module to and from the user's face.

In another embodiment, the HMD may further include a head-mounting mechanism that secures the HMD to the user's head.

A corresponding method of assembling an HMD with peripheral viewing is also described. The method may include (1) retaining, in a housing, a display unit configured to display computer-generated imagery to a user and (2) coupling the housing to a head-mounting mechanism configured to mount the HMD on the user's head. When the HMD is mounted on the user's head and the display unit is positioned in a forward field of view of the user, the display unit may obstruct at least a portion of the user's forward field of view, and the housing may be dimensioned to provide the user with a substantially unobstructed peripheral view of a real-world environment of the user.

In another embodiment, the method may include mechanically coupling a positioning mechanism between the display unit and the housing. In this example, the positioning mechanism may be configured to adjustably position the display unit between at least (1) a viewing position in which the display unit is positioned in the user's forward field of view and (2) a non-viewing position in which the display unit is positioned substantially outside of the user's forward field of view.

In another embodiment, the method may include disposing one or more optical elements adjacent the display unit to provide a focused view of the computer-generated imagery displayed by the display unit. In one example, the method may include applying an anti-reflective coating to the one or more optical elements to suppress stray light from the user's real-world environment.

In another embodiment, the method may include attaching a removable enclosure to the housing to block the user's peripheral view of the real-world environment.

In another embodiment, the method may include attaching a nose grip module to the housing to adjustably secure the housing to the user's face. In one example, the method may include configuring the nose grip module with a linear actuator to linearly actuate the display unit towards the user's face.

In another embodiment, the method may include mechanically coupling an attachment mechanism and a slidable adjustment mechanism to the housing. In this example, the attachment mechanism may slidably attach to the housing via the slidable adjustment mechanism to position the housing towards the user's face.

In another embodiment, the head-mounting mechanism may include at least one of a strap assembly or a band device.

In one embodiment, a removable enclosure for HMDs is provided. The removable enclosure may include (1) a main body and (2) an attachment mechanism, coupled to the main body, that is configured to removably attach the removable enclosure to an HMD that comprises a display unit and a housing that retains the display unit. When the removable enclosure is removably attached to the HMD, the HMD is mounted on a user's head, and the display unit is positioned in a forward field of view of the user, the removable enclosure may block a peripheral view of a real-world environment of the user. And, when the removable enclosure is detached from the HMD, the housing may be dimensioned to provide the user with a substantially unobstructed peripheral view of the real-world environment.

In another embodiment, the display unit may include at least one optical element configured with an anti-reflective coating that suppresses stray light from the user's real-world environment.

In another embodiment, the housing may include a positioning mechanism that mechanically couples to the display unit and adjustably positions the display unit in the user's forward field of view.

In another embodiment, the housing may include a linearly actuating nose grip module that secures the housing to the user's face and that adjustably changes a distance between the display unit and the user's eyes.

In another embodiment, the housing may include an attachment mechanism and a slidable adjustment mechanism. In this example, the attachment mechanism of the housing may slidably attach to the housing via the slidable adjustment mechanism to position the housing towards the user's face.

In another embodiment, the attachment mechanism of the housing may include a compression fit attachment that snaps to one or more eye cups configured with the housing.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a block diagram of an exemplary HMD system.

FIG. 2 is an illustration of an exemplary HMD.

FIG. 3 is a block diagram of an exemplary field of view that may be provided by embodiments of this disclosure.

FIG. 4 is an overhead view of an exemplary HMD device according to certain embodiments of this disclosure.

FIG. 5 is a frontal view of the exemplary HMD device of FIG. 4.

FIG. 6 is a frontal view of the exemplary HMD device of FIG. 4 configured with a strap assembly.

FIG. 7 is an overhead view of the exemplary HMD device of FIG. 6 configured with a removably attached enclosure.

FIG. 8 is a side view of the exemplary HMD device of FIG. 7.

FIG. 9 is a perspective view of the exemplary HMD of FIG. 7.

FIGS. 10 and 11 are side views of the exemplary HMD device of FIG. 6.

FIG. 12 is an exploded perspective view of the exemplary HMD of FIG. 6.

FIG. 13 is a side/cut away view of an exemplary nose grip module that may be used in connection with embodiments of this disclosure.

FIG. 14 is a perspective view of the exemplary nose grip module of FIG. 13.

FIG. 15 is a perspective view of the optional enclosure of FIGS. 7-9.

FIG. 16 is a flow diagram of an exemplary method for configuring an HMD with peripheral viewing.

FIG. 17 is a flow diagram of exemplary steps that may be implemented with the method of FIG. 16.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to an HMD device configured to provide a user with a substantially unobstructed peripheral view of the user's real-world environment. When worn by the user, the HMD device may allow the user to see both computer-generated imagery via a display of the HMD device in the user's forward field of view and the real-world environment in the user's periphery. This may in turn enable the user to visually interact with real objects in the user's periphery, such as keyboards, mice, styluses, beverage containers, steering wheels, etc., while still participating in an artificial reality environment. Both traditional and compact lens configurations (e.g., Fresnel and so-called pancake lenses) may be employed. The HMD device may also include various ergonomic features, such as a counter-balanced “halo” strap assembly, adjustable nose grips (that enable the user to adjust the distance between the display and the user's eyes), an adjustable positioning component (such as a hinge that allows the user to flip the display panel up and away from the user's field of view), etc. The HMD device may have a single display panel or multiple display panels (e.g., one for each eye) and may be configured with or without interpupillary distance (IPD) adjustment mechanisms. In some examples, a peripheral display enclosure may be removably attached to the HMD device so that the user can transition between fully immersive virtual-reality experiences (e.g., with a blocked peripheral view of the real-world environment) and mixed-reality experiences (e.g., with an open peripheral view of the real-world environment).

Embodiments of the present disclosure may include or be implemented in conjunction with various types of artificial reality systems. Artificial reality is a form of reality that has been adjusted in some manner before presentation to a user, which may include, e.g., a virtual-reality, an augmented reality, a mixed reality, a hybrid reality, or some combination and/or derivative thereof. Artificial-reality content may include completely generated content or generated content combined with captured (e.g., real-world) content. The artificial-reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., to perform activities in) an artificial reality.

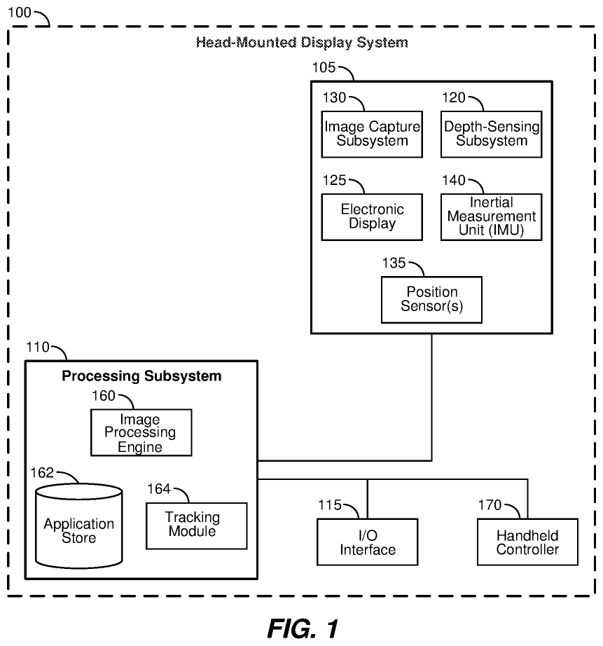

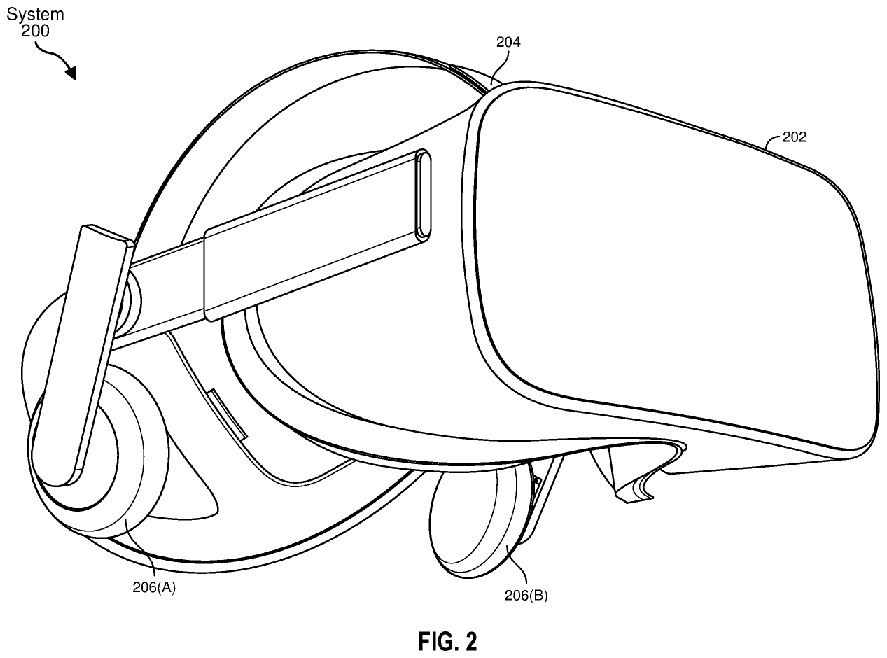

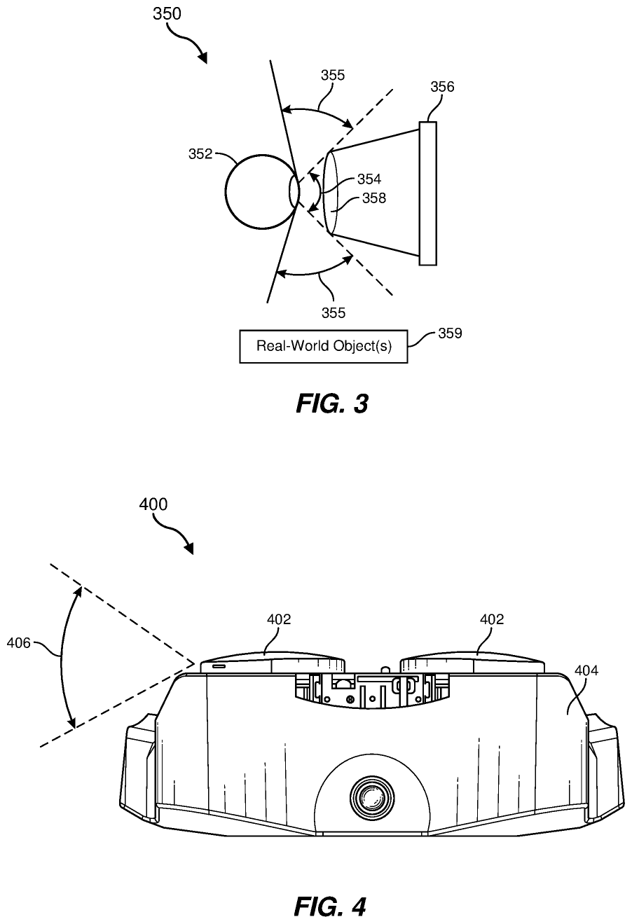

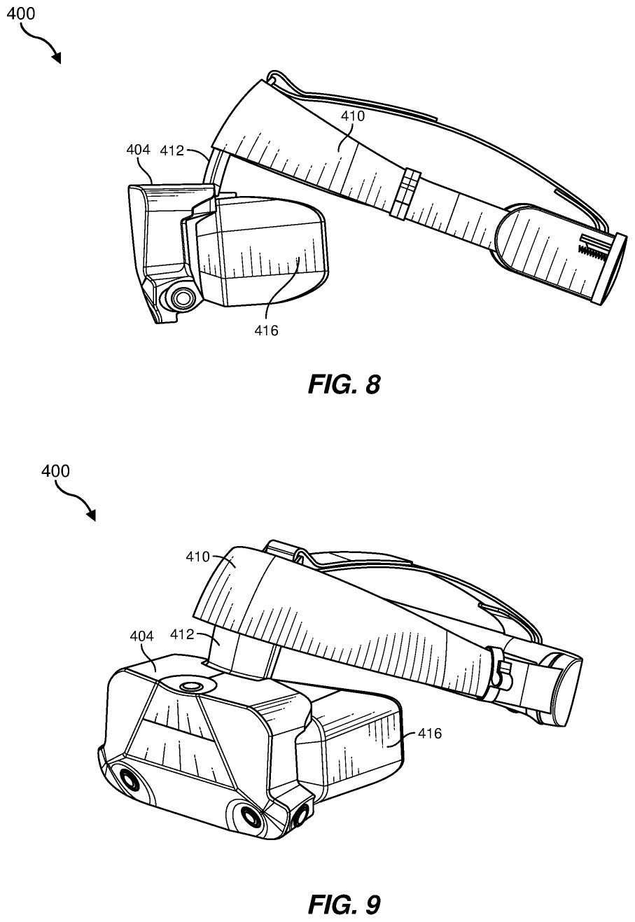

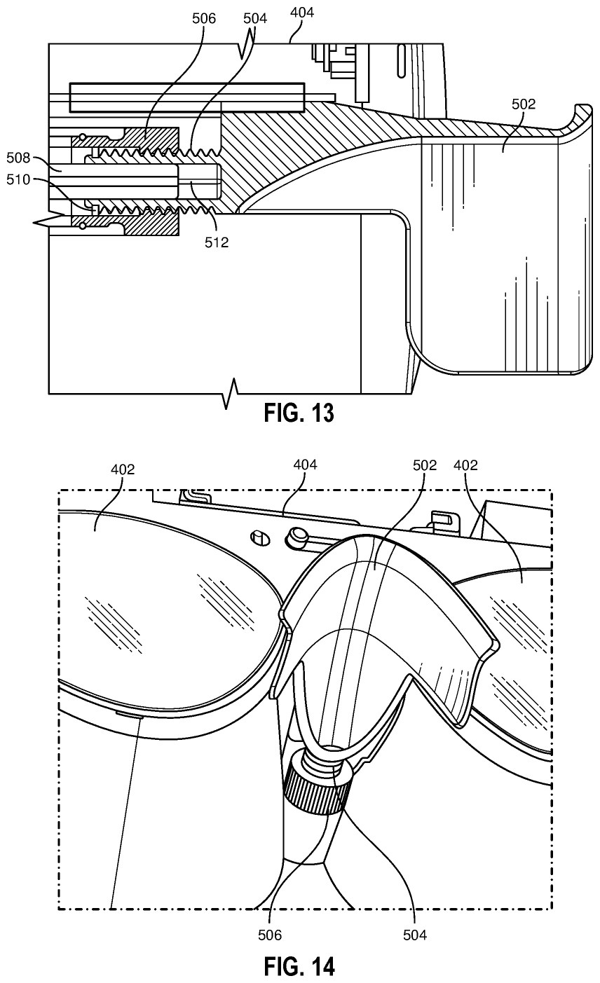

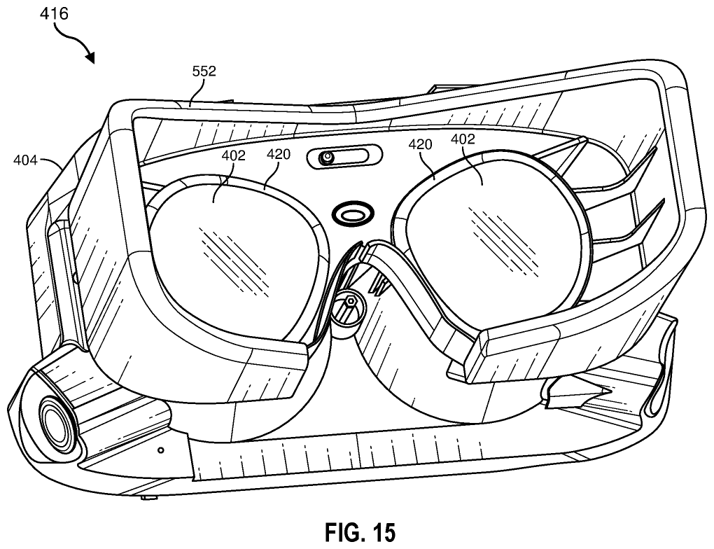

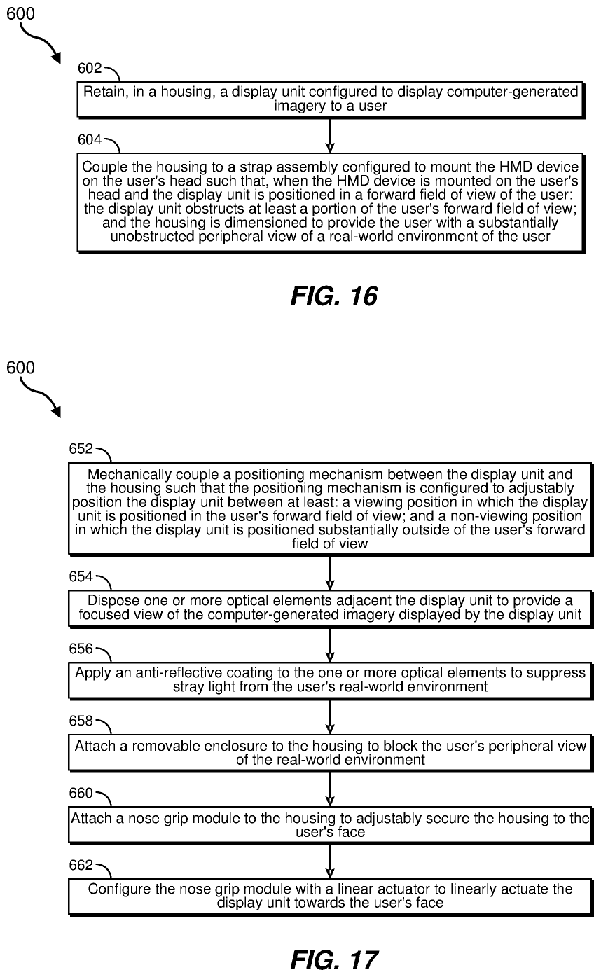

The following will provide, with reference to FIGS. 1-17, detailed descriptions of systems and methods for providing unobstructed peripheral viewing with an HMD device. First, a description of an exemplary HMD system is presented in reference to FIGS. 1 and 2. FIG. 3 illustrates an exemplary field of view that may be provided by an HMD device in connection with some embodiments of this disclosure. FIGS. 4-12 illustrate various views and exemplary configurations of an HMD device in connection with some embodiments of this disclosure. FIGS. 13 and 14 illustrate a nose grip module that may be configured with the HMD device embodiments disclosed herein. FIG. 15 illustrates a removable enclosure that may be attached to the HMD device disclosed herein. FIG. 16 is a flow diagram of an exemplary method for assembling an HMD device capable of providing peripheral viewing in connection with some embodiments of this disclosure. FIG. 17 is a flow diagram of exemplary steps that may be implemented with the method of FIG. 16.

Turning to FIG. 1, a block diagram is presented of an exemplary HMD system 100 that may present virtual scenes (e.g., captured scenes, artificially-generated scenes, or a combination thereof) to a user. HMD system 100 may operate in a VR environment, an augmented reality environment, a mixed reality environment, or some combination thereof. HMD system 100 shown in FIG. 1 may include an HMD device 105 that includes or communicates with a processing subsystem 110 and an input/output (I/O) interface 115. As will be explained in greater detail below, HMD device 105 may completely obstruct the user's view of the real-world environment, in some embodiments. In other embodiments, HMD device 105 may only partially obstruct the user's view of the real-world environment and/or may obstruct the user's view depending on content being displayed in a display of HMD device 105. For example, HMD device 105 may be configured to allow substantially unobstructed peripheral viewing of the user's real-world environment, as explained in greater detail below.

While FIG. 1 shows an exemplary HMD system 100 that includes at least one HMD device 105 and at least one I/O interface 115, in other embodiments any number of these components may be included in HMD system 100. In embodiments in which processing subsystem 110 is not included within or otherwise integrated with HMD device 105, HMD device 105 may communicate with processing subsystem 110 over a wired connection or a wireless connection. In alternative configurations, different and/or additional components may be included in HMD system 100. Additionally, functionality described in connection with one or more of the components shown in FIG. 1 may be distributed among the components in a different manner than that described with respect to FIG. 1, in some embodiments.

HMD device 105 may present a variety of content to a user, including virtual views of an artificially rendered virtual-world environment and/or augmented views of a physical, real-world environment. Augmented views may be augmented with computer-generated elements (e.g., two-dimensional (2D) or three-dimensional (3D) images, 2D or 3D video, sound, etc.). In some embodiments, the presented content may include audio that is provided via an internal or external device (e.g., speakers and/or headphones) that receives audio information from HMD device 105, processing subsystem 110, or both, and presents audio data based on the audio information. In some embodiments, the speakers and/or headphones may be integrated into, or releasably coupled or attached to, HMD device 105. HMD device 105 may include one or more bodies, which may be rigidly or non-rigidly coupled together. A rigid coupling between rigid bodies may cause the coupled rigid bodies to act as a single rigid entity. In contrast, a non-rigid coupling between rigid bodies may allow the rigid bodies to move relative to each other. Particular embodiments of HMD device 105 are virtual-reality system 200 (shown in FIG. 2), HMD device 350 (shown in FIG. 3), and HMD device 400 (shown in FIG. 4), each of which is described in further detail below.

In some examples, HMD device 105 may include a depth-sensing subsystem 120 (e.g., a depth camera subsystem), an electronic display 125, an image capture subsystem 130 that includes one or more cameras, one or more position sensors 135, and/or an inertial measurement unit (IMU) 140. One or more of these components may provide a positioning subsystem of HMD device 105 that can determine the position of HMD device 105 relative to a real-world environment and individual features contained therein. Other embodiments of HMD device 105 may include an optional eye-tracking or gaze-estimation system configured to track the eyes of a user of HMD device 105 to estimate the user's gaze. Some embodiments of HMD device 105 may have different components than those described in conjunction with FIG. 1.

Depth-sensing subsystem 120 may capture data describing depth information characterizing a local real-world area or environment surrounding some or all of HMD device 105. In some embodiments, depth-sensing subsystem 120 may characterize a position and/or velocity of depth-sensing subsystem 120 (and thereby of HMD device 105) within the local area. Depth-sensing subsystem 120, in some examples, may compute a depth map using collected data (e.g., based on captured light according to one or more computer-vision schemes or algorithms, by processing a portion of a structured light pattern, by time-of-flight (ToF) imaging, simultaneous localization and mapping (SLAM), etc.). Additionally or alternatively, depth-sensing subsystem 120 can transmit this data to another device, such as an external implementation of processing subsystem 110, that may generate a depth map using the data from depth-sensing subsystem 120. As described herein, the depth maps may be used to generate a model of the environment surrounding HMD device 105. Accordingly, depth-sensing subsystem 120 may be referred to as a localization and modeling subsystem or may be a part of such a subsystem.

Electronic display 125 may display 2D or 3D images to the user in accordance with data received from processing subsystem 110. In various embodiments, electronic display 125 may include a single electronic display or multiple electronic displays (e.g., a display for each eye of the user). Examples of electronic display 125 may include, but are not limited to, a liquid crystal display (LCD), an organic light-emitting diode (OLED) display, an inorganic light-emitting diode (ILED) display, an active-matrix organic light-emitting diode (AMOLED) display, a transparent organic light-emitting diode (TOLED) display, another suitable display, or some combination thereof. In some examples, electronic display 125 may be opaque such that the user cannot see the local environment through electronic display 125.

Image capture subsystem 130 may include one or more optical image sensors or cameras that capture and collect image data from the local environment. In some embodiments, the sensors included in image capture subsystem 130 may provide stereoscopic views of the local environment that may be used by processing subsystem 110 to generate image data that characterizes the local environment and/or a position and orientation of HMD device 105 within the local environment. In some embodiments, the image data may be processed by processing subsystem 110 or another component of image capture subsystem 130 to generate a three-dimensional view of the local environment. For example, image capture subsystem 130 may include SLAM cameras or other cameras that include a wide-angle lens system that captures a wider field-of-view than may be captured by the eyes of the user.

In some embodiments, processing subsystem 110 may process the images captured by image capture subsystem 130 to extract various aspects of the visual appearance of the local real-world environment. For example, image capture subsystem 130 may capture color images of the real-world environment that provide information regarding the visual appearance of various features within the real-world environment. Image capture subsystem 130 may capture the color, patterns, etc. of the walls, the floor, the ceiling, paintings, pictures, fabric textures, etc., in the room. These visual aspects may be encoded and stored in a database. Processing subsystem 110 may associate these aspects of visual appearance with specific portions of the model of the real-world environment so that the model can be rendered with the same or similar visual appearance at a later time.

IMU 140, in some examples, may represent an electronic subsystem that generates data indicating a position and/or orientation of HMD device 105 based on measurement signals received from one or more of position sensors 135 and/or from depth information received from depth-sensing subsystem 120 and/or image capture subsystem 130. For example, position sensors 135 may generate one or more measurement signals in response to the motion of HMD device 105. Examples of position sensors 135 include one or more accelerometers, one or more gyroscopes, one or more magnetometers, another suitable type of sensor that detects motion, a type of sensor used for error correction of IMU 140, or some combination thereof. Position sensors 135 may be located external to IMU 140, internal to IMU 140, or some combination thereof.

Based on the one or more measurement signals from one or more of position sensors 135, IMU 140 may generate data indicating an estimated current position, elevation, and/or orientation of HMD device 105 relative to an initial position and/or orientation of HMD device 105. This information may be used to generate a personal zone that can be used as a proxy for the user's position within the local environment. For example, position sensors 135 may include multiple accelerometers to measure translational motion (forward/back, up/down, left/right) and multiple gyroscopes to measure rotational motion (e.g., pitch, yaw, roll). As described herein, image capture subsystem 130 and/or depth-sensing subsystem 120 may generate data indicating an estimated current position and/or orientation of HMD device 105 relative to the real-world environment in which HMD device 105 is used.

I/O interface 115 may represent a subsystem or device that allows a user to send action requests and receive responses from processing subsystem 110 and/or a hand-secured or handheld controller 170. In some embodiments, I/O interface 115 may facilitate communication with more than one handheld controller 170. For example, the user may have two handheld controllers 170, with one in each hand. An action request may, in some examples, represent a request to perform a particular action. For example, an action request may be an instruction to start or end the capture of image or video data, an instruction to perform a particular action within an application, or an instruction to start or end a boundary definition state. I/O interface 115 may include one or more input devices or may enable communication with one or more input devices. Exemplary input devices may include, but are not limited to, a keyboard, a mouse, a handheld controller (which may include a glove or a bracelet), or any other suitable device for receiving action requests and communicating the action requests to processing subsystem 110.

An action request received by I/O interface 115 may be communicated to processing subsystem 110, which may perform an action corresponding to the action request. In some embodiments, handheld controller 170 may include a separate IMU 140 that captures inertial data indicating an estimated position of handheld controller 170 relative to an initial position. In some embodiments, I/O interface 115 and/or handheld controller 170 may provide haptic feedback to the user in accordance with instructions received from processing subsystem 110 and/or HMD device 105. For example, haptic feedback may be provided when an action request is received or when processing subsystem 110 communicates instructions to I/O interface 115, which may cause handheld controller 170 to generate or direct generation of haptic feedback when processing subsystem 110 performs an action.

Processing subsystem 110 may include one or more processing devices or physical processors that provide content to HMD device 105 in accordance with information received from one or more of depth-sensing subsystem 120, image capture subsystem 130, IMU 140, I/O interface 115, and/or handheld controller 170. In the example shown in FIG. 1, processing subsystem 110 may include an image processing engine 160, an application store 162, and a tracking module 164. Some embodiments of processing subsystem 110 may have different modules or components than those described in conjunction with FIG. 1. Similarly, the functions further described herein may be distributed among the components of HMD system 100 in a different manner than described in conjunction with FIG. 1.

Application store 162 may store one or more applications for execution by processing subsystem 110. An application may, in some examples, represent a group of instructions that, when executed by a processor, generates content for presentation to the user. Such content may be generated in response to inputs received from the user via movement of HMD device 105 and/or handheld controller 170. Examples of such applications may include gaming applications, conferencing applications, video playback applications, social media applications, and/or any other suitable applications.

Tracking module 164 may calibrate HMD system 100 using one or more calibration parameters and may adjust one or more of the calibration parameters to reduce error when determining the position of HMD device 105 and/or handheld controller 170. For example, tracking module 164 may communicate a calibration parameter to depth-sensing subsystem 120 to adjust the focus of depth-sensing subsystem 120 to more accurately determine positions of structured light elements captured by depth-sensing subsystem 120. Calibration performed by tracking module 164 may also account for information received from IMU 140 in HMD device 105 and/or another IMU 140 included in handheld controller 170. Additionally, if tracking of HMD device 105 is lost or compromised (e.g., if depth-sensing subsystem 120 loses line-of-sight of at least a threshold number of structured light elements), tracking module 164 may recalibrate some or all of HMD system 100.

Tracking module 164 may track movements of HMD device 105 and/or handheld controller 170 using information from depth-sensing subsystem 120, image capture subsystem 130, the one or more position sensors 135, IMU 140, or some combination thereof. For example, tracking module 164 may determine a position of a reference point of HMD device 105 in a mapping of the real-world environment based on information collected with HMD device 105. Additionally, in some embodiments, tracking module 164 may use portions of data indicating a position and/or orientation of HMD device 105 and/or handheld controller 170 from IMU 140 to predict a future position and/or orientation of HMD device 105 and/or handheld controller 170. Tracking module 164 may also provide the estimated or predicted future position of HMD device 105 and/or I/O interface 115 to image processing engine 160.

In some embodiments, tracking module 164 may track other features that can be observed by depth-sensing subsystem 120, image capture subsystem 130, and/or another system. For example, tracking module 164 may track one or both of the user's hands so that the location of the user's hands within the real-world environment may be known and utilized. To simplify the tracking of the user within the real-world environment, tracking module 164 may generate and/or use a proxy for the user. The proxy can define a personal zone associated with the user, which may provide an estimate of the volume occupied by the user. Tracking module 164 may monitor the user's position in relation to various features of the environment by monitoring the user's proxy or personal zone in relation to the environment. Tracking module 164 may also receive information from one or more eye-tracking cameras included in some embodiments of HMD device 105 to track the user's gaze.

Image processing engine 160 may generate a three-dimensional mapping of the area surrounding some or all of HMD device 105 (i.e., the “local area” or “real-world environment”) based on information received from HMD device 105. In some embodiments, image processing engine 160 may determine depth information for the three-dimensional mapping of the local area based on information received from depth-sensing subsystem 120 that is relevant for techniques used in computing depth. Image processing engine 160 may calculate depth information using one or more techniques in computing depth from structured light. In various embodiments, image processing engine 160 may use the depth information, e.g., to generate and/or update a model of the local area and generate content based in part on the updated model. Image processing engine 160 may also extract aspects of the visual appearance of a scene so that a model of the scene may be more accurately rendered at a later time, as described herein.

Image processing engine 160 may also execute applications within HMD system 100 and receive position information, acceleration information, velocity information, predicted future positions, or some combination thereof, of HMD device 105 from tracking module 164. Based on the received information, image processing engine 160 may identify content to provide to HMD device 105 for presentation to the user. For example, if the received information indicates that the user has looked to the left, image processing engine 160 may generate content for HMD device 105 that corresponds to the user's movement in a virtual environment or in an environment augmenting the local area with additional content. To provide the user with awareness of his or her surroundings, image processing engine 160 may present a combination of the virtual environment and the model of the real-world environment. Additionally, image processing engine 160 may perform an action within an application executing on processing subsystem 110 in response to an action request received from I/O interface 115 and/or handheld controller 170 and provide visual, audible, and/or haptic feedback to the user that the action was performed.

Artificial-reality systems, such as HMD device 105, may be implemented in a variety of different form factors and configurations. Some artificial reality systems may be designed to work without near-eye displays (NEDs). Other artificial reality systems may include an NED that also provides visibility into the real world or that visually immerses a user in an artificial reality (e.g., virtual-reality system 200 below in FIG. 2). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

As noted, some artificial reality systems may, instead of blending an artificial reality with actual reality, substantially replace one or more of a user's sensory perceptions of the real world with a virtual experience. One example of this type of system is a head-worn display system, such as virtual-reality system 200 in FIG. 2 that mostly or completely encloses a user's field of view. Virtual-reality system 200 may include a front rigid body 202 and a band 204 shaped to fit around a user's head. Virtual-reality system 200 may also include output audio transducers 206(A) and 206(B). Furthermore, while not shown in FIG. 2, front rigid body 202 may include one or more electronic elements, including one or more electronic displays, one or more inertial measurement units (IMUS), one or more tracking emitters or detectors, and/or any other suitable device or system for creating an artificial reality experience.

Artificial reality systems may include a variety of types of visual feedback mechanisms. For example, display devices in virtual-reality system 200 may include one or more liquid crystal displays (LCDs), light emitting diode (LED) displays, organic LED (OLED) displays, and/or any other suitable type of display screen. Artificial reality systems may include a single display screen for both eyes or may provide a display screen for each eye, which may allow for additional flexibility for varifocal adjustments or for correcting a user's refractive error. Some artificial reality systems may also include optical subsystems having one or more lenses (e.g., conventional concave or convex lenses, Fresnel lenses, adjustable liquid lenses, etc.) through which a user may view a display screen.

FIG. 3 is a side view block diagram of a user 352 interacting with an exemplary HMD device 350. HMD device 350 may be representative of HMD device 105 in FIG. 1, virtual-reality system 200 in FIG. 2, and/or HMD device 400 in FIG. 4, among others. As detailed above, HMD device 350 may be dimensioned to enable user 352 to simultaneously view both computer-generated imagery shown on an opaque display unit (such as electronic display 125 from FIG. 1) and portions of the user's real-world environment in the user's periphery, thereby providing a mixed reality (MR) environment. For example, HMD device 350 may include an opaque display unit (e.g., electronic display 125) that displays computer-generated and/or other imagery (such as pass-through images from an external-facing camera) to user 352 in user 352's forward field of view 354. HMD device 350 may also include a housing 356 that retains the display unit, among other items (including, e.g., one or more optical elements 358, such as lenses, that focus light from the display, eye cups, onboard electronics, cameras, etc.). As shown in this figure, housing 356 may be dimensioned so as to provide user 352 with a substantially unobstructed peripheral view 355 of the user's real-world environment. For example, HMD device 350 may be configured such that, when HMD device 350 is worn by user 352, the only substantial portion of HMD device 350 that is within the forward field of view 354 of user 352 is the one or more optical elements 358 and the display unit, leaving peripheral view 355 of user 352 substantially unobstructed. This may advantageously allow user 352 to more aptly interact with one or more objects 359 in a real-world environment, such as keyboards, computer mice, styluses, pens, pencils, beverage containers, steering wheels, etc.

The term “forward field of view,” as used herein, may include various portions of a user's central visual field, including all or portions of the user's macular field of view (e.g., a field of view that spans approximately 18° in diameter, centered around the user's gaze or fixation point), which may encompass the user's central field of view (e.g., a field of view that spans approximately 5° in diameter, centered around the user's gaze or fixation point) and paracentral field of view (e.g., a field of view that spans approximately 8° in diameter). Similarly, the term “peripheral field of view,” as used herein, may include various portions of a user's non-central visual field, including all or portions of the user's far-peripheral field of view (e.g., a field of view that spans approximately 220° in diameter, centered around the user's gaze or fixation point), mid-peripheral field of view (e.g., a field of view that spans approximately 120° in diameter, centered around the user's gaze or fixation point), and near-peripheral field of view (e.g., a field of view that spans approximately 60° in diameter, centered around the user's gaze or fixation point). In some examples, the term “forward field of view” may also encompass portions of the user's non-central visual field, including all or portions of a user's near-peripheral field of view (e.g., a field of view that spans approximately 60° in diameter, centered around the user's gaze or fixation point) and mid-peripheral field of view (e.g., a field of view that spans approximately 120° , centered around the user's gaze or fixation point).

HMD device 350 may be configured and dimensioned in a variety of ways to provide a user with a variety of differing peripheral views of their real-world environment. In one example, HMD device 350 may be configured and dimensioned such that HMD device 350 only obstructs all or a portion of the user's central field of view, leaving all or a portion of the user's paracentral, near-peripheral, mid-peripheral, and far-peripheral fields of view substantially unobstructed. In other examples, HMD device 350 may be configured and dimensioned such that HMD device 350 only obstructs all or a portion of the user's central and paracentral fields of view, leaving all or a portion of the user's near-peripheral, mid-peripheral, and far-peripheral fields of view substantially unobstructed. In another example, HMD device 350 may be configured and dimensioned such that HMD device 350 only obstructs all or a portion of the user's macular field of view, leaving all or a portion of the user's near-peripheral, mid-peripheral, and far-peripheral fields of view substantially unobstructed. In addition, HMD device 350 may be configured and dimensioned such that HMD device 350 only obstructs all or a portion of the user's macular and near-peripheral fields of view, leaving all or a portion of the user's mid-peripheral and far-peripheral fields of view substantially unobstructed. Similarly, HMD device 350 may be configured and dimensioned such that HMD device 350 only obstructs all or a portion of the user's macular, near-peripheral, and mid-peripheral fields of view, leaving all or a portion of the user's far-peripheral field of view substantially unobstructed.

As noted, HMD device 350 may also include one or more optical elements 358 in optical communication with the display unit that provide a focused view of the computer-generated imagery presented by the display unit. Examples of optical elements that may be used in HMD device 350 include concave and convex lenses, Fresnel lenses, compact or so-called pancake lenses, and the like. In some examples, optical elements 358 may include an anti-reflective coating that suppresses stray light from the real-world environment so as to improve viewing of the imagery presented by the display unit. In some examples, an antireflective coating may refer to a type of optical coating applied to a surface of a lens and other optical elements to reduce reflection. Examples of antireflective coatings include refractive index matching coatings, single-layer interference coatings, multilayer interference coatings, absorbing coatings, circular polarizing coatings, etc.

Another example of HMD device 105, virtual-reality system 200, and HMD device 350 includes HMD device 400 of FIGS. 4-12. In this example, HMD device 400 can be configured to cover a user's forward field of view while allowing the user to freely view their real-world environment in their periphery. As noted, HMD device 400 may include a front rigid body and a strap assembly or band shaped to fit around a user's head, such as halo band 410 illustrated in FIGS. 6-12. HMD device 400 may also include one or more electronic elements, including one or more electronic displays, one or more inertial measurement units (IMUS), one or more tracking emitters or detectors, and/or any other suitable device or system for creating an artificial reality experience, as detailed above.

In FIG. 4, HMD device 400 is shown in an overhead view without a band to illustrate an exemplary peripheral field of view 406 of a user. As detailed above, housing 404 may be dimensioned in such a way that the user's peripheral field of view 406 is substantially unobstructed when HMD device 400 is positioned proximate to the user's face. In this example, little to no portion of housing 404, other than a display unit housed within housing 404, may be in the user's forward field of view.

In one example, the display unit is opaque. Thus, HMD device 400 may obstruct the user's forward field of view of their real-world environment. However, this configuration may also enable the user to simultaneously view both imagery displayed by the opaque display unit (e.g., computer-generated imagery) and the user's real-world environment in the user's periphery. HMD device 400 may also include a pair of optical elements 402 (e.g., lenses) to provide a focused view of any imagery displayed by the display unit.

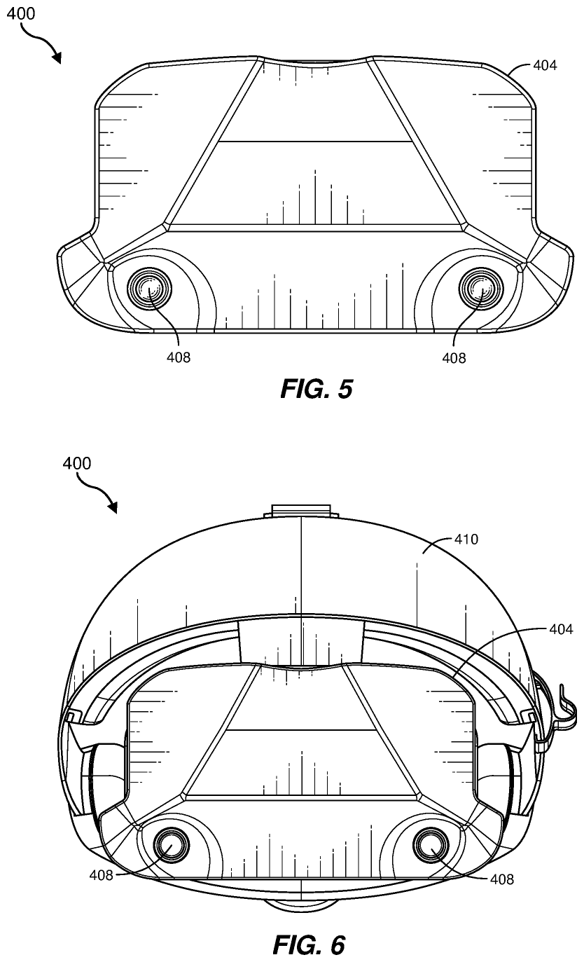

FIG. 5 is a frontal view of HMD device 400, illustrating the opaque nature of HMD device 400. HMD device 400 may be configured with forward-facing camera modules 408 to provide imagery to the display unit and/or to provide tracking information to a tracking module, such as tracking module 164 of FIG. 1.

FIG. 6 is a frontal view of HMD device 400 configured with halo band 410. Halo band 410 may be configured to mount HMD device 400 to the user's head. Halo band 410 may also be configured with one or more adjustment and positioning mechanisms that allow the user to position housing 404 proximate to or away from the user's face, as will be explained below. However, other types of head-mounting mechanisms may be used to secure HMD device 400 to the user's head, such as custom-fitted halo bands that require little to no adjustment and strap assemblies.

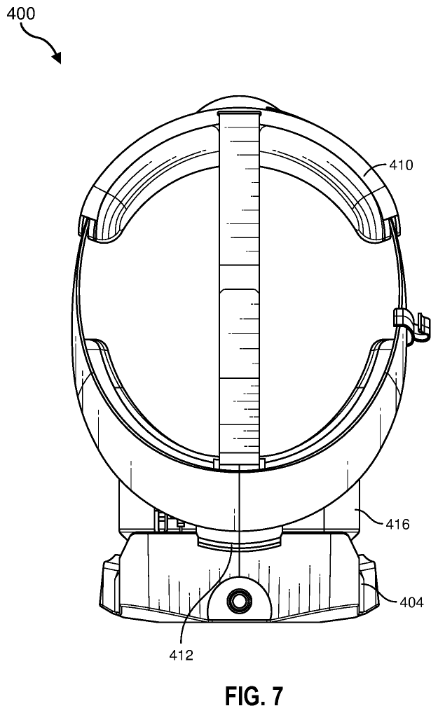

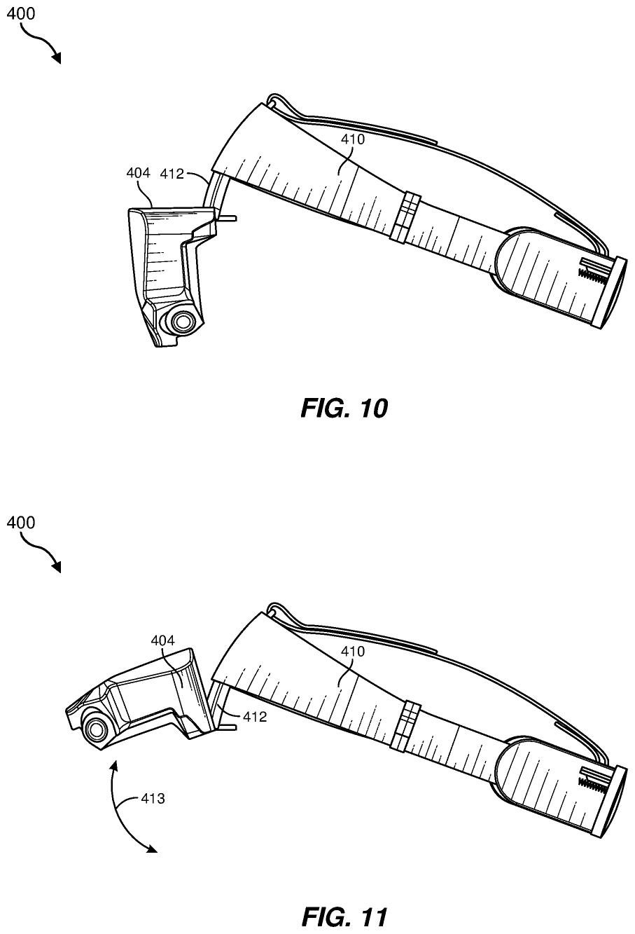

FIGS. 7, 8, and 9 are overhead, side, and perspective views, respectively, of exemplary HMD device 400 illustrating halo band 410. In one example, halo band 410 may include a positioning mechanism 412 that enables the user to flip housing 404 up and down, much like a visor. For example, positioning mechanism 412 may include a hinge-like device that allows housing 404 to move in a vertical manner with respect to the user's face, as illustrated and described below in connection with FIGS. 10 and 11.

Thus, when housing 404 is flipped up and away from the user's face (via the positioning mechanism), housing 404 may be removed from at least a portion of the user's forward field of view, which may enable the user to interact with others and/or real-world objects in the user's forward field of view. Housing 404 may also include certain ergonomic features, such as a nose grip module, to comfortably rest HMD device 400 on the user's nose in front of the user's face. Halo band 410 may also be configured with counterbalancing mechanisms (e.g., the back portion of halo band 410 may be weighted to offset the weight of HMD device 400) to ensure steady placement of HMD device 400 with respect to the user's face. Other embodiments may include a positioning mechanism that allows housing 404 to move in a sideways manner with respect to the user's face. For example, the positioning mechanism may allow the user to move housing 404 away from the user's face in a left and/or right direction with respect to the user's face, much like a “swinging gate”.

Also illustrated in FIGS. 7, 8, and 9 is a removable enclosure 416 that enables a user to selectively allow external light into, or block external light from entering, HMD device 400. For example, enclosure 416 may be removably attached to housing 404 when the user wishes to switch from an MR environment to a full VR environment. One example of enclosure 416 is shown and described in greater detail in FIG. 15.

FIGS. 10 and 11 are sides view of exemplary HMD device 400 with optional enclosure 416 removed. As can be seen in FIG. 10, housing 404 of HMD device 400 is positioned in a “visor down” position via positioning mechanism 412. Thus, when a user is wearing HMD device 400, the user sees the display unit (e.g., via optical elements 402) in the user's forward field of view. However, since enclosure 416 is removed, the user's peripheral field of view is open to their real-world environment, allowing the user to interact with objects in the real-world environment (e.g., keyboards, computer mice, styluses, pens, pencils, steering wheels, beverage containers, etc.).

In FIG. 11, HMD device 400 is configured to position housing 404 in a “visor up” position via positioning mechanism 412, as indicated by vertical motion arrow 413. Thus, housing 404 is positioned such that the display unit is no longer in the user's forward field of view, thereby allowing the user to more freely interact with people and objects in the user's forward field of view of the real-world environment. In some embodiments, HMD device 400 may include a switch that powers off the display unit and/or other components of HMD device 400 so as to conserve power when HMD device 400 is positioned in the visor up position. In other embodiments, the display unit may remain operational such that the user may observe an artificial reality environment in the user's peripheral view. As noted, HMD device 400 may be alternatively configured to move housing 404 in other manners, such as a “swinging gate” configuration that allows the user to remove housing 404 from the user's forward field of vision by swinging housing 404 to the left and/or to the right of the user's face.

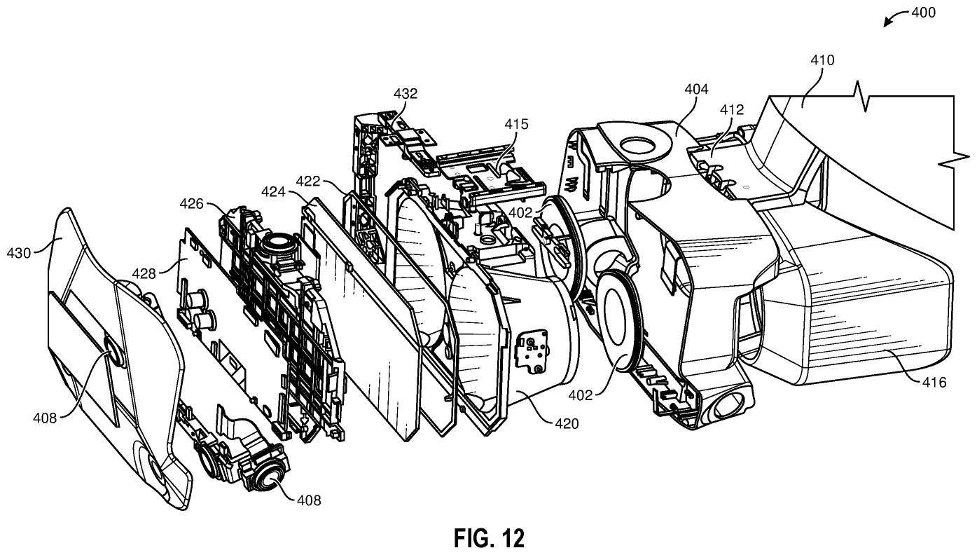

FIG. 12 is an exploded perspective view of exemplary HMD device 400 illustrating various components and construction of the same. Housing 404 may adjustably attach to halo band 410 via an adjustment mechanism 415. In addition, enclosure 416 may be removably attached to halo band 410 and/or housing 404 when the user wishes to immerse in a full VR environment, as detailed above. Optical elements 402 may mount to eye cups 420 to provide a focused view of display unit 424. As mentioned above, optical elements 402 may be coated with an anti-reflective coating to block stray light entering from the user's periphery, thereby enhancing the user's viewing of display unit 424.

Attachment mechanism 422 may attach display unit 424 to eye cups 420. Module 432 may secure housing 404 to halo band 410 via adjustment mechanism 415. For example, adjustment mechanism 415 may affix to halo band 410. Module 432 may then mechanically couple to adjustment mechanism 415 such that housing 404, and the components therein, can mount to halo band 410. Module 432 may slidably attach to adjustment mechanism 415 such that the user can position HMD device 400 toward or away from the user's face.

Motherboard mount 426 may secure motherboard 428 to display unit 424. HMD device 400 may also include one or more camera modules 408, which may provide forward viewing of a scene to the user when HMD device 400 is worn. And, front cover 430 may secure to housing 404 to enclose the components of HMD device 400 (e.g., camera modules 408, motherboard 428, motherboard mount 426, display unit 424, eye cups 420, etc.). HMD device 400 may be configured in other ways with fewer or more components designed and/or dimensioned to fit within housing 404.

FIGS. 13 and 14 illustrate side/cut away and perspective views, respectively, of exemplary nose grip module 502 that may be configured with housing 404. Nose grip module 502 may be configured from any of a variety of materials including, for example, latex rubber, plastic, metal, and wood. Nose grip module 502 is configured in such a way as to comfortably rest housing 404 on the user's nose (e.g., while being supported/suspended by halo band 410) such that the display unit is directly in the user's forward field of view. Nose grip module 502 may also be dimensioned so as to not obstruct the user's forward and peripheral fields of view.

In one example, nose grip module 502 may be configured with an adjustment mechanism to position housing 404, and thus optical elements 402, towards or away from the user's face. For example, nose grip module 502 may be configured with a linear actuator mechanism (e.g., a lead screw, a ball screw, a roller screw, a rack and pinion mechanism, an electromotive actuator, etc.) that moves housing 404 back and forth as desired, thereby adjustably changing a distance between housing 404 and the user's face. In this example, nose grip module 502 may be configured with screw mechanism 504. Screw mechanism 504 may be configured with a channel 512 which may slide onto a guide pin 508 configured in housing 404. A screw wheel 506 configured in housing 404 may be rotated to screw onto screw mechanism 504 of nose grip module 502. For example, rotating screw wheel 506 in one direction may move nose grip module 502 closer to the user's face, thus positioning housing 404 away from the user's face. Rotating screw wheel 506 in the opposite direction may move nose grip module 502 towards housing 404, thus positioning housing 404 closer to the user's face. As such, nose grip module 502 may provide a mechanism for adjusting the distance between a display and the user's eyes.

In one embodiment, screw mechanism 504 may be configured with a gasket 510 to provide a stop position. For example, gasket 510 may prevent screw mechanism 504 from traversing past a predetermined point within screw wheel 506 in one or both directions of linear actuation. In this example, channel 512 may be configured to limit linear actuation of nose grip module 502 in one direction (e.g., towards housing 404) to the end of guide pin 508.

FIG. 15 is a perspective view of an optional enclosure of FIGS. 7-9 that may be removably attached to housing 404 of HMD device 400. Enclosure 416 may include a main body 552. Main body 552 may be rigid or semi-rigid. For example, main body 552 may be configured from a rigid plastic with padding for comfort when worn or main body 552 may be configured from a semi-rigid material such as rubber. Enclosure 416 may also include an attachment mechanism (not visible) that is configured to removably attach enclosure 416 to HMD device 400. For example, enclosure 416 may be removably attached to housing 404 of HMD device 400 in a variety of ways, including via a tongue-and-groove attachment mechanism, via a compression fit, via hook-and-loop fasteners, via buttons, via snaps, etc. In one example, enclosure 416 may be snapped (e.g., via a compression fit) to eye cups 420 configured within housing 404.

When removable enclosure 416 is removably attached to HMD device 400, HMD device 400 is mounted on a user's head, and the display unit of HMD device 400 is positioned in a forward field of view of the user, removable enclosure 416 may block a peripheral view of a real-world environment of the user. For example, when enclosure 416 is attached to HMD device 400, enclosure 416 may block out light from the user's periphery to fully surround the user's viewing. And, when removable enclosure 416 is detached from HMD device 400, housing 404 may be dimensioned to provide the user with a substantially unobstructed peripheral view of the real-world environment. Because enclosure 416 is removably attachable to HMD device 400, enclosure 416 may allow a user to quickly and easily transition between fully immersive VR experiences (with a blocked peripheral view of the real-world environment) and mixed-reality experiences (with an open peripheral view of the real-world environment).

FIG. 16 is a flow diagram of an exemplary method 600 for assembling an HMD device, such as HMD device 105, virtual-reality system 200, HMD device 350, and/or HMD device 400 above. Method 600 may include, at step 602, retaining, in a housing (e.g., housing 404 above), a display unit (e.g., display unit 424 and associated components, such as optical elements 402, eye cups 420, etc. of FIG. 12) configured to display computer-generated imagery to a user. At step 604, method 600 may include coupling the housing to a strap assembly, such as halo band 410 above, configured to mount the HMD device on the user's head. When the HMD device is mounted on the user's head and the display unit is positioned in a forward field of view of the user, the display unit may obstruct at least a portion of the user's forward field of view, and the housing may be dimensioned to provide the user with a substantially unobstructed peripheral view of a real-world environment of the user.

FIG. 17 is a flow diagram of exemplary steps that may be implemented with method 600 of FIG. 16. For example, method 600 may include mechanically coupling a positioning mechanism (e.g., positioning mechanism 412 above) between the display unit and the housing at step 652. In this example, the positioning mechanism may be configured to adjustably position the display unit between at least a viewing position in which the display unit is positioned in the user's forward field of view, and a non-viewing position in which the display unit is positioned substantially outside of the user's forward field of view.

In one embodiment, method 600 may include disposing one or more optical elements (e.g., optical elements 402 above) adjacent the display unit to provide a focused view of the computer-generated imagery displayed by the display unit at step 654. In this example, method 600 may also include applying an anti-reflective coating to the one or more optical elements to suppress stray light from the user's real-world environment at step 656.

In one embodiment, method 600 may include attaching a removable enclosure, such as enclosure 416 above, to the housing to block the user's peripheral view of the real-world environment at step 658. In another embodiment, method 600 may include attaching a nose grip module, such as nose grip module 502 of FIGS. 13 and 14, to the housing to adjustably secure the housing to the user's face at step 660. In this example, method 600 may include configuring the nose grip module with a linear actuator (e.g., screw wheel 506, screw mechanism 504, guide pin 508, channel 512, etc. of FIGS. 13 and 14) to linearly actuate the display unit towards the user's face at step 662.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

As detailed above, the systems and methods disclosed herein may provide a user-changeable HMD device that can enable a user to quickly enter a mixed reality experience or a fully immersive virtual-reality experience. In the mixed reality experience, the user may detach an enclosure and mount the HMD device to the user's head. From there, the user may lower a display unit of the HMD device in the user's forward field of view to view computer-generated imagery displayed by the display unit. A housing of the HMD device that retains the display unit may be dimensioned in such a way as to only make the display unit visible to the user's forward field of view when the display unit is positioned in the user's forward field of view. Thus, the user may observe or otherwise interact with objects (keyboards, computer mice, steering wheels, pens, pencils, beverage containers, etc.) and people in a real-world environment in the user's peripheral field of view. The housing may also be configured with a positioning mechanism that allows the user to position the housing out of the user's forward field of view (e.g., like a visor) as desired.

In the virtual-reality experience, the user may attach the enclosure to the housing (e.g., via compression fit, hook-and-loop fasteners, buttons, snaps, etc.) to substantially block out external light from the real-world environment. This removably attachable enclosure may allow the user to quickly and easily switch between a virtual-reality experience and a mixed reality experience. And, the positioning mechanism may still allow the user to move the housing out of the user's forward field of view.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A head-mounted display comprising:
a display unit configured to display computer-generated imagery to a user; and
a housing that retains the display unit;
wherein, when the head-mounted display is mounted on the user's head and the display unit is positioned in a forward field of view of the user:
the display unit obstructs at least a portion of the user's forward field of view; and
the housing is dimensioned to provide the user with a substantially unobstructed peripheral view of a real-world environment of the user.

2. The head-mounted display of claim 1, further comprising a positioning mechanism that mechanically couples the display unit to the housing and that adjustably positions the display unit between at least:
a viewing position in which the display unit is positioned in the user's forward field of view; and
a non-viewing position in which the display unit is positioned substantially outside of the user's forward field of view.

3. The head-mounted display of claim 1, further comprising an optical element in optical communication with the display unit that provides a focused view of the computer-generated imagery.

4. The head-mounted display of claim 3, wherein the optical element comprises an anti-reflective coating that suppresses stray light from the user's real-world environment.

5. The head-mounted display of claim 1, further comprising a removable enclosure that removably attaches to the housing to block the user's peripheral view of the real-world environment.

6. The head-mounted display of claim 5, wherein the removable enclosure comprises:
a main body; and
an attachment mechanism, coupled to the main body, that is configured to removably attach the removable enclosure to the housing.

7. The head-mounted display of claim 6, wherein the attachment mechanism comprises a compression fit attachment that snaps to one or more eye cups configured with the housing.

8. The head-mounted display of claim 1, wherein the housing comprises a nose grip module that adjustably secures the housing to the user's face.

9. The head-mounted display of claim 8, wherein the housing further comprises a linear actuator configured to move the display unit towards the user's face.

10. The head-mounted display of claim 1, further comprising a head-mounting mechanism that secures the head-mounted display to the user's head.

11. A method of assembling a head-mounted display, comprising:
retaining, in a housing, a display unit configured to display computer-generated imagery to a user; and
coupling the housing to a head-mounting mechanism configured to mount the head-mounted display on the user's head;
wherein, when the head-mounted display is mounted on the user's head and the display unit is positioned in a forward field of view of the user:
the display unit obstructs at least a portion of the user's forward field of view; and
the housing is dimensioned to provide the user with a substantially unobstructed peripheral view of a real-world environment of the user.

12. The method of claim 11, further comprising:
mechanically coupling a positioning mechanism between the display unit and the housing, wherein the positioning mechanism is configured to adjustably position the display unit between at least:
a viewing position in which the display unit is positioned in the user's forward field of view; and
a non-viewing position in which the display unit is positioned substantially outside of the user's forward field of view.

13. The method of claim 11, further comprising disposing one or more optical elements adjacent the display unit to provide a focused view of the computer-generated imagery displayed by the display unit.

14. The method of claim 13 , further comprising applying an anti-reflective coating to the one or more optical elements to suppress stray light from the user's real-world environment.

15. The method of claim 11, further comprising attaching a removable enclosure to the housing with an attachment mechanism to block the user's peripheral view of the real-world environment.

16. The method of claim 15, wherein the attachment mechanism comprises a compression fit attachment that snaps to one or more eye cups configured with the housing.

17. The method of claim 11, further comprising attaching a nose grip module to the housing to adjustably secure the housing to the user's face.

18. The method of claim 17, further comprising configuring the nose grip module with a linear actuator to linearly actuate the display unit towards the user's face.

19. The method of claim 11, further comprising mechanically coupling an attachment mechanism and a slidable adjustment mechanism to the housing, wherein the attachment mechanism slidably attaches to the housing via the slidable adjustment mechanism to position the housing towards the user's face.

20. The method of claim 11, wherein the head-mounting mechanism is at least one of a strap assembly or a band device.
